(19) United States
(12) Patent Application Publication
(10) Pub. No.: US 2009/0178430 A1
(43) Pub. Date: Jul. 16, 2009

(54) Ice-cube tray and refrigerator unit and/or freezer unit having such an ice-cube tray

(76) Inventors: Holger Jendrusch, Rot an der Rot (DE); Florian Oberhauser, Assling (AT); Rudolf Kanzian, Dellach/Gail (AT); Richard Stocker, Lienz (AT)

Correspondence Address: DILWORTH & BARRESE, LLP, 1000 WOODBURY ROAD, SUITE 405, WOODBURY, NY, 11797, US

(21) Appl. No.: 12/288,713

(22) Filed: Oct. 22, 2008

(30) Foreign Application Priority Data
Oct. 23, 2007 (DE) UM 202007014786.4

(51) Int. Cl. B28B 7/08; F25C 1/10; B28B 7/24

(52) U.S. Cl. 62/345; 249/111; 249/120

(57) ABSTRACT

The present invention relates to an ice-cube tray for the making of ice-cubes, wherein the ice-cube tray has a material at least regionally which is provided with one or more additives by means of which the heat conductivity is increased.

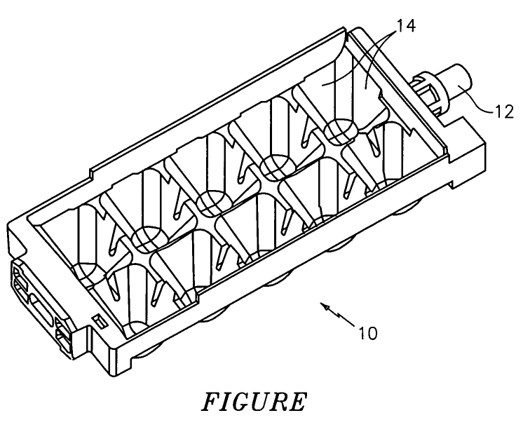

The present invention relates to an ice-cube tray for the making of ice-cubes as well as to a refrigerator unit and/or a freezer unit having such an ice-cube tray.

It is known from the prior art to make refrigerator units and/or freezer units with an ice-cube maker in which water is frozen to ice which is then dispensed as required. It is, for example, conceivable that the water is filled into the ice-cube tray of the ice-cube maker via a valve system and that a dispensing of ice cubes takes place from the ice-cube tray into a container as soon as the water has frozen.

It is the underlying object of the present invention to further develop an ice-cube tray such that the time period required for the freezing of the water is cut with respect to known units.

This object is solved by an ice-cube tray having the features of claim 1.

Provision is accordingly made that the ice-cube tray has a material at least regionally which is provided with one or more additives by means of which the heat conductivity is increased. It is thus the underlying idea of the invention to increase the heat conductivity of the ice-cube tray, which has the result that the water in the ice-cube tray can be brought to the ambient temperature faster, i.e. freezes faster.

The time duration required for the freezing of the ice-cubes is thus cut and the performance of an ice-cube maker is increased accordingly.

Provision is made in an embodiment of the invention that the additives are embedded in the material. It is thus conceivable, for example, to embed additives, such as aluminum particles which result in an increase in conductivity, in a matrix, made of plastic, for example. The ice-cube tray thus has a larger heat conductivity at least regionally than without these additives.

Alternatively or additionally to this, it is possible to apply the additives to the material in the form of a coating. The coating can, for example, be arranged on the inner side and/or on the outer side of the ice-cube tray.

The additives can be any desired materials which result in an increase of the conductivity of the ice-cube tray overall. Metals, in particular aluminum, are suitable, for example, or also metal compounds such as alloys and the like.

These additives can, for example, be introduced in the form of particles which are present in the form of needles, spheres, platelets and the like.

It is also conceivable that the additives are carbonic compounds or elementary carbon such as is present in the form of graphite.

The use of a plastic enriched with graphite is thus conceivable, for example.

Provision is made in a further embodiment of the invention that the material provided with the additive or additives is made such that a torsion of the ice-cube tray around at least one axis is possible. With rotationally supported ice-cube trays, there is a possibility of emptying the ice-cube tray in that it is set into a rotary tray around at least one axis is possible. With rotationally supported ice-cube trays, there is a possibility of emptying the ice-cube tray in that it is set into a rotary movement, with this rotary movement being suppressed or inhibited by an abutment, for example in an end region of the ice-cube tray, such that torsion of the ice-cube tray takes place. In this manner, ice-cubes release from the ice-cube tray and fall into a collection container arranged thereunder, for example. Provision is preferably made that this torsion property is not lost due to the named additives.

Provision is made in a further embodiment of the invention that the material is plastic. It is, for example, conceivable to use polypropylene as the material, for example, which is provided with the named additives. The use of different plastic materials or also of mixtures of plastics is naturally also possible.

The invention furthermore relates to an ice-cube tray for the making of ice-cubes which is characterized in that the ice-cube tray is at least regionally made of a material or comprises a material which has a higher heat conductivity than polypropylene. The use of plastics or of other non-metallic materials is conceivable as is also the use of metals or of metallic materials. It is, for example, conceivable to produce the ice-cube maker in a plastic material which has a higher heat conductivity than polypropylene in order in this manner to effect a cooling of the water which is as fast as possible and thus a freezing process which is as fast as possible.

Provision is also made in this case in a preferred embodiment of the invention that a torsion of the ice-cube tray around at least one axis is possible to allow its emptying, provided that the emptying is based on a rotation or a torsion of the ice-cube tray.

The present invention furthermore relates to a refrigerator unit and/or freezer unit having an ice-cube maker which has an ice-cube tray in accordance with one of the claims 1 to 9.

this respect which inhibits or prevents the rotary movement of the ice-cube tray. Provision is made in a preferred embodiment of the invention that the rotary movement of the ice-cube tray is inhibited or prevented from a specific angle of rotation.

Further details and advantages of the invention will be explained in more detail with reference to an embodiment shown in the drawing:

The only FIGURE shows an ice-cube tray in accordance with the present invention in a perspective representation.

To increase the cooling rate of the water and thereby to achieved shorter cycle times, the ice-cube tray 10 in accordance with the FIGURE is made such that the walls of the ice-cube tray have a greater heat conductivity than it is the case with known ice-cube trays made of polypropylene. This property can apply to the total ice-cube tray or also only to a partial region such as the walls 14 which are directly adjacent to the water or ice. The walls 14 bound individual compartments of the tray 10 for the reception of water.

It is the aim to increase the heat conductivity of the ice-cube tray to be able to bring the product to be frozen to the temperature of the environment of the ice-cube tray faster.

Provision is made in the embodiment shown here that the ice-cube tray 10 has to have a torsion property which is required for the emptying of this embodiment of the tray. The ice-cube tray is furthermore made such that it also withstands a large number of cycles.

Provision is made in this embodiment that the ice-cube tray 10 is made of a material which has similar mechanical properties to polypropylene, but an increased heat conductivity.

Provision is made in particular that the ice-cube tray is made of polypropylene in which aluminum particles or graphite have been embedded. The ice-cube tray can thus be made of plastic with aluminum particles or also of a plastic enriched with graphite. The plastic can be polypropylene, for example.

The ice-cube tray 10 in accordance with the FIGURE is at an ambient temperature of less than 0° C. in an ice-cube maker. The ice-cube tray 10 shown is rotationally supported in the ice-cube maker, for which purpose the rotational axle 12 serves.

The ice-cube tray 10 is filled with water via a valve system in operation. As soon as the water has frozen, the ice-cube tray 10 is rotated by an actuator.

Torsion of the tray 10 is necessary for the emptying of the ice-cube tray 10. An abutment, not shown, is provided for this purpose which suppresses the rotary movement of the tray 10 at one side from a preset angle onward. The ice-cubes release from the tray 10 due to the torsion of the ice-cube tray 10 and fall into a collection container, not shown, which is located beneath the tray 10, for example.

1. An ice-cube tray for the making of ice-cubes, wherein the ice-cube tray has a material at least regionally which is provided with one or more additives by which the heat conductivity is increased.

2. An ice-cube tray in accordance with claim 1, wherein the additives are embedded in the material; and/or the additive or additives are made in the form of a coating of the material.

3. An ice-cube tray in accordance with claim 1, wherein the additive or additives are metals, in particular aluminum, or metal compounds.

4. An ice-cube tray in accordance with claim 1, wherein the additive or additives are carbonic compounds or carbon, in particular graphite.

5. An ice-cube tray in accordance with claim 1, wherein the material provided with the additive or additives is made such that a torsion of the ice-cube tray around at least one axis is possible.

6. An ice-cube tray in accordance with claim 1, wherein the material is plastic.

7. An ice-cube tray for the making of ice-cubes wherein the ice-cube tray is made at least regionally of a material or comprises a material which has a higher heat conductivity than polypropylene.

8. An ice-cube tray in accordance with claim 7, wherein the material is plastic.

9. An ice-cube tray in accordance with claim 7, wherein the material is made such that torsion of the ice-cube tray around at least one axis is possible.

10. A refrigerator unit and/or a freezer unit, wherein the unit has an ice-cube maker having an ice-cube tray in accordance with claim 1.

11. A refrigerator unit and/or a freezer unit in accordance with claim 10, wherein the ice-cube tray is rotationally supported.

12. A refrigerator unit and/or a freezer unit in accordance with claim 11, wherein an abutment is provided which inhibits or prevents the rotary movement of the ice-cube tray.

13. A refrigerator unit and/or a freezer unit in accordance with claim 12, wherein the abutment is made such that it inhibits or prevents the rotary movement of the ice-cube tray from a specific angle of rotation onward.

14. An ice-cube tray in accordance with claim 2, wherein the additive or additives are metals, in particular aluminum, or metal compounds.

15. An ice-cube tray in accordance with claim 14, wherein the additive or additives are carbonic compounds or carbon, in particular graphite.

16. An ice-cube tray in accordance with claim 2, wherein the additive or additives are carbonic compounds or carbon, in particular graphite.

17. An ice-cube tray in accordance with claim 3, wherein the additive or additives are carbonic compounds or carbon, in particular graphite.

18. An ice-cube tray in accordance with claim 17, wherein the material provided with the additive or additives is made such that a torsion of the ice-cube tray around at least one axis is possible.

19. An ice-cube tray in accordance with claim 16, wherein the material provided with the additive or additives is made such that a torsion of the ice-cube tray around at least one axis is possible.

20. An ice-cube tray in accordance with claim 15, wherein the material provided with the additive or additives is made such that a torsion of the ice-cube tray around at least one axis is possible.
